(19) United States
(12) Patent Application Publication
(10) Pub. No.: US 2026/0249570 A1
(43) Pub. Date: Aug. 27, 2026

(54) METHOD OF PRODUCING SEALING MATERIAL AND SEALING MATERIAL

(71) Applicant: VALQUA, LTD., Tokyo (JP)

(72) Inventors: Sayaka Yoshida, Gojo-shi, Nara (JP); Kenichi Takahashi, Gojo-shi, Nara (JP); Akira Ueda, Gojo-shi, Nara (JP); Kenn Suzuki, Gojo-shi, Nara (JP)

(73) Assignee: VALQUA, LTD., Tokyo (JP)

(21) Appl. No.: 19/160,103

(22) PCT Filed: Feb. 28, 2024
(86) PCT No.: PCT/JP2024/007270

§ 371 Date: Aug. 27, 2025

(30) Foreign Application Priority Data
Mar. 2, 2023 (JP) 2023-032181

(51) Int. Cl. B29C 70/78; B29C 33/40; B29C 70/68; B29K 23/00; B29K 705/12; B29L 31/26; C09D 123/00; C09D 133/04; C09D 163/00

(52) U.S. Cl. CPC B29C 70/78; B29C 33/40; B29C 70/681; C09D 123/00; C09D 133/04; C09D 163/00; B29K 2023/22; B29K 2705/12; B29K 2827/18; B29L 2031/26

(57) ABSTRACT

The present disclosure relates to a method of producing a sealing material in a continuous manner, the method comprising: a filling step to fill an ultraviolet-curable sealing material composition into a mold; and an irradiation step to irradiate the ultraviolet-curable sealing material composition with ultraviolet rays, wherein the mold transmits ultraviolet rays. The present disclosure is capable of providing a method of producing a sealing material where production time is relatively short and heat production tends not to occur at the time of curing, as well as such a sealing material

### TECHNICAL FIELD

The present invention relates to a method of producing a sealing material, and it also relates to a sealing material.

### BACKGROUND ART

Japanese Patent Laying-Open No. 2017-177720 discloses a method of producing a sealing material by filling a thermally crosslinkable rubber composition into a mold and performing hot press molding.

### CITATION LIST

### Patent Literature

PTL 1: Japanese Patent Laying-Open No. 2017-177720

### SUMMARY OF INVENTION

### Technical Problem

The sealing material production method described by Japanese Patent Laying-Open No. 2017-177720 requires a relatively long time for crosslinking the thermally crosslinkable rubber composition, and, therefore, it is difficult to reduce the time for producing the sealing material. Moreover, hot press molding produces a great amount of heat, leading to high emission of carbon dioxide.

The present invention provides a method of producing a sealing material where production time is relatively short and heat production tends not to occur at the time of curing, as well as such a sealing material.

### Solution to Problem

The present invention provides a method of producing a sealing material as well as a sealing material described below.

[1] A method of producing a sealing material in a continuous manner, the method comprising:
a filling step to fill an ultraviolet-curable sealing material composition into a mold; and
an irradiation step to irradiate the ultraviolet-curable sealing material composition with ultraviolet rays, wherein
the mold transmits ultraviolet rays.

[2] The method of producing a sealing material according to [1], wherein the mold is made of tetrafluoroethylene-(perfluoroalkyl vinyl ether) copolymer.

[3] The method of producing a sealing material according to [1] or [2], wherein the ultraviolet-curable sealing material composition contains an ultraviolet-curable resin component and a photopolymerization initiator.

[4] The method of producing a sealing material according to any one of [1] to [3], wherein the ultraviolet-curable resin component includes a polyolefin-based resin, an acrylic resin, or an epoxy resin.

[5] The method of producing a sealing material according to any one of [1] to [4], wherein the method further includes at least one step selected from the group consisting of a mold preparation step, a mold releasing step, an inspection step, a cleaning step, a mold-release-agent application step, and a packaging step.

[6] The method of producing a sealing material according to any one of [1] to [5], wherein the method includes a step to place one type selected from the group consisting of a film, a plate, and a formed article.

[7] The method of producing a sealing material according to any one of [1] to [6], wherein the sealing material is produced continuously in at least one mode selected from the group consisting of a linear mode, a multi-line mode, and a rotational mode.

[8] The method of producing a sealing material according to any one of [1] to [7], wherein a plurality of steps are combined and implemented as one step.

[9] The method of producing a sealing material according to any one of [1] to [8], wherein a plurality of steps are implemented in parallel.

[10] A sealing material comprising a cured product of an ultraviolet-curable sealing material composition.

[11] The sealing material according to [10], wherein the ultraviolet-curable sealing material composition includes an acrylic resin or an epoxy resin.

### Advantageous Effects of Invention

The present invention is capable of providing a method of producing a sealing material where production time is relatively short and heat production tends not to occur at the time of curing, as well as such a sealing material.

### BRIEF DESCRIPTION OF DRAWINGS

FIG. 1 is a flowchart illustrating the method of producing a sealing material according to the present invention.

FIG. 2 is a view for schematically explaining the mode for continuously producing a sealing material.

FIG. 3 is a perspective view schematically illustrating a production apparatus used in the method of producing a sealing material according to the present invention.

FIG. 4 is a perspective view schematically illustrating a mold used in the method of producing a sealing material according to the present invention.

FIG. 5 is a cross-sectional view schematically illustrating a filling apparatus and a mold used in the method of producing a sealing material according to the present invention.

FIG. 6 is a schematic view of a cross section of the sealing material according to the present invention.

### DESCRIPTION OF EMBODIMENTS

In the following, a description will be given of embodiments of the present invention with reference to drawings, but the below embodiments do not limit the scope of the present invention. In each drawing below, the scale has been changed as appropriate for the purpose of assisting the understanding of the components; therefore, the scale of the components in the drawings may not necessarily coincide with the actual scale of the components.

### Method of Producing Sealing Material

A method of producing a sealing material according to the present invention is a method of producing a sealing material in a continuous manner, and the method comprises a filling step to fill an ultraviolet-curable sealing material composition into a mold as well as an irradiation step to irradiate the ultraviolet-curable sealing material composition with ultraviolet rays, wherein the mold transmits ultraviolet rays.

The method of producing a sealing material according to the present invention cures the ultraviolet-curable sealing material composition by irradiation with ultraviolet rays, and therefore, as compared to when performing thermal crosslinking of a thermally crosslinkable rubber composition, less time is required for producing the sealing material and heat tends not to be produced. In addition, in the method of producing a sealing material according to the present invention, the mold transmits ultraviolet rays, and therefore, it is possible to cure the ultraviolet-curable sealing material composition while it remains inside the mold, by irradiating the ultraviolet-curable sealing material composition with ultraviolet rays through the mold. Hence, even though it uses an ultraviolet-curable sealing material composition, the method of producing a sealing material according to the present invention is capable of producing sealing materials of various shapes and tends to have excellent molding workability.

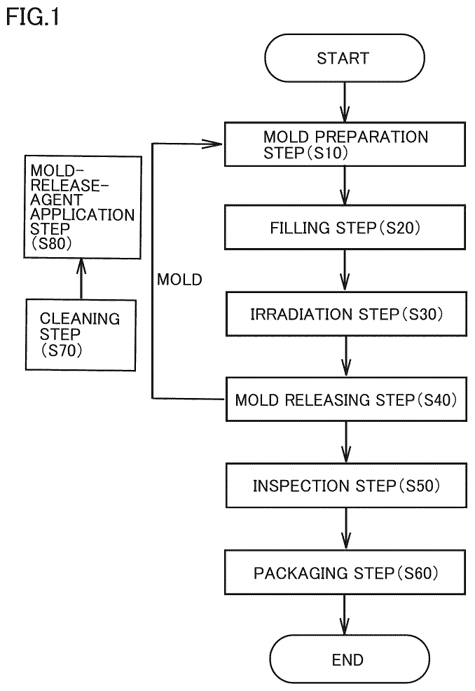

The method of producing a sealing material illustrated in FIG. 1 includes a filling step (S20) to fill an ultraviolet-curable sealing material composition into a mold, and an irradiation step (S30) to irradiate the ultraviolet-curable sealing material composition with ultraviolet rays. In addition to these steps, the method of producing a sealing material can further include other steps. Examples of these other steps include a mold preparation step, a mold releasing step, an inspection step, a cleaning step, a mold-release-agent application step, a packaging step, and the like. The method of producing a sealing material can include, in the mold preparation step, a step to place one type selected from the group consisting of a film, a plate, and a formed article. As illustrated in FIG. 1, the method of producing a sealing material can further include a mold preparation step (S10) to prepare (assemble) a mold, a mold releasing step (S40) to take out the sealing material from the mold, an inspection step (S50) to inspect the sealing material thus taken out, a packaging step (S60) to package the sealing material, a cleaning step (S70) to clean the mold before it is sent back to the mold preparation step (S10), a mold-release-agent application step (S80) to apply a mold release agent to the mold thus cleaned, and/or the like, for example.

The method of producing a sealing material is capable of implementing the filling step and the irradiation step in a continuous manner. Referring to FIG. 1, the mold preparation step (S10) to the mold-release-agent application step (S80) can be implemented continuously. After the mold releasing step (S40), by sending the mold back to the mold preparation step (S10), it is possible to repeat the above-mentioned steps in a continuous manner. By using a plurality of molds, it is possible to produce many sealing materials in a short time.

The mode to continuously produce the sealing material is not particularly limited, and examples thereof include a mode to implement the above-mentioned steps in sequence by transferring the mold in a linear manner (hereinafter also called a linear mode), a mode to place a plurality of linear modes beside each other and implement them (hereinafter also called a multi-line mode), a mode to implement the above-mentioned steps by transferring the mold in a concentric manner (hereinafter also called a rotational mode), and the like. Moreover, a plurality of steps may be combined and implemented as one step, and/or a plurality of steps may be implemented in parallel.

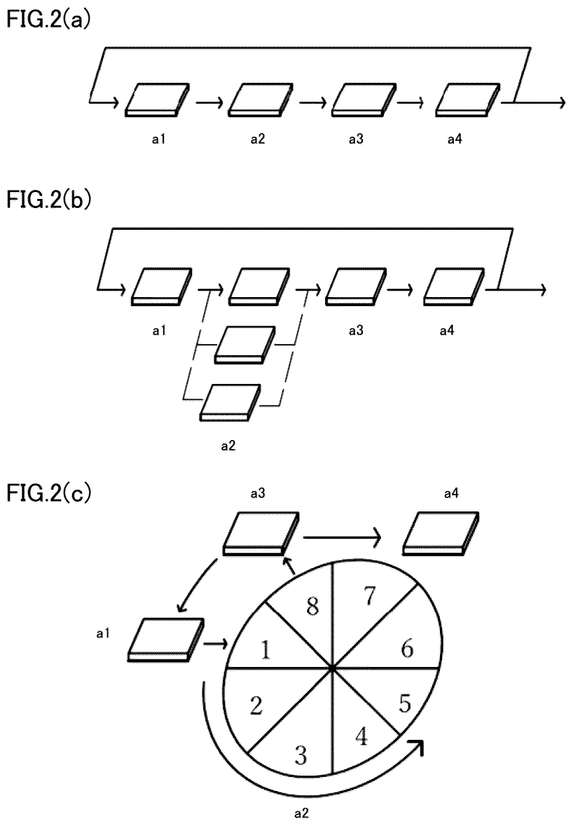

FIG. 2 is a view for explaining the mode of continuously producing the sealing material, with the mold-transfer direction indicated by arrows. The mode illustrated in FIG. 2(a) is a linear mode in which steps a1, a2, a3, and a4 are implemented continuously in this order, where the mold is collected in the step a4 (for example, a mold releasing step) and sent back to the step a1 (for example, a mold preparation step). The mode illustrated in FIG. 2(b) is a linear mode in which the steps a1, a2, a3, and a4 are implemented continuously in this order while the step a2 is implemented multiple times in parallel, where the mold is collected in the step a4 (for example, a mold releasing step) and the mold is sent back to the step a1 (for example, a mold preparation step). The mode illustrated in FIG. 2(c) is a rotational mode in which the steps a1, a2, a3, and a4 are implemented continuously in this order, where in the step a2, the mold is transferred concentrically in the order of 1 to 8 for performing the processing. For example, as illustrated in FIG. 2(c), it is also possible to take out the product from the mold in the step a3 (for example, a mold releasing step), send the mold back to the step a1 (for example, a mold preparation step), and transfer the product to the subsequent step a4 (for example, an inspection step and the like).

In the method of producing a sealing material, the time (tact time, takt time: time for producing one product) starting from the mold preparation step, for example, via the filling step and the irradiation step to the mold releasing step to take out the sealing material may be 60 seconds or less, for example, and it can be preferably 50 seconds or less, more preferably 40 seconds or less, further preferably 30 seconds or less, particularly preferably 20 seconds or less, specially preferably 10 seconds or less.

In the method of producing a sealing material, a sealing material production apparatus can be used. As for the sealing material production apparatus, a plurality of apparatuses to be used for implementing the above-mentioned steps may be positioned along a straight line, and/or some of or all of the plurality of apparatuses may be positioned in parallel to each other, and/or the plurality of apparatuses may be positioned concentrically; and these arrangements may be combined.

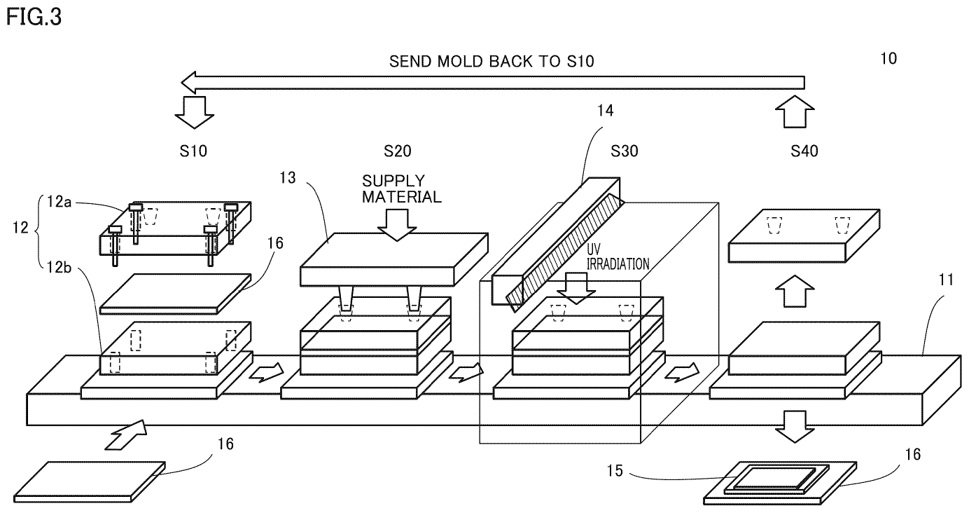

FIG. 3 illustrates a sealing material production apparatus in a linear mode. Referring to a sealing material production apparatus 10 illustrated in FIG. 3, the method of producing a sealing material according to the present invention will be described.

Production apparatus 10 includes a transfer apparatus 11, a mold 12, a filling apparatus 13, and a UV irradiator 14 positioned along a straight line. Mold 12 is positioned on transfer apparatus 11 in the mold preparation step (S10), and transferred to the filling step (S20) where an ultraviolet-curable sealing material composition is filled into mold 12 by filling apparatus 13; then the resultant is irradiated with ultraviolet rays in the irradiation step (S30); after curing, mold 12 is removed in the mold releasing step (S40); and thus a sealing material 15 is produced. Mold 12 can be sent back to the mold preparation step.

As transfer apparatus 11, a conveyor belt, a free flow conveyor, a linear conveyor module, a transfer roll, a transfer arm, and/or the like can be used, for example.

In the mold preparation step, mold 12 is prepared. As illustrated in the drawings, mold 12 can be assembled from an upper mold 12a and a lower mold 12b. After combined, for example, upper mold 12a and lower mold 12b can be fixed to each other with a screw and/or the like. In the case where mold 12 is composed of upper mold 12a and lower mold 12b as illustrated in FIG. 3, a substrate 16 on which a sealing material is to be formed may be placed between upper mold 12a and lower mold 12b. Substrate 16 may be one type selected from the group consisting of a film, a plate, and a formed article, for example. Substrate 16 may be a metal plate and/or the like, for example, and preferably, it may be made of stainless steel (SUS) and/or the like. Substrate 16, together with the sealing material, may be included in the product.

As for the ultraviolet-transmitting capability of mold 12, the transmittance for light at a wavelength of 365 nm may be 80% or more, for example, and from the viewpoint of the curability of the ultraviolet-curable sealing material composition, it is preferably 90% or more, more preferably 95% or more, and it is usually 100% or less. The entire mold 12 may transmit ultraviolet rays, or only a portion intended for curing the ultraviolet-curable sealing material composition may transmit ultraviolet rays.

Mold 12 may be made of an ultraviolet-transmitting material; for example, it is possible that the entire mold 12 is made of an ultraviolet-transmitting material or, alternatively, it is possible that only an ultraviolet-transmitting portion of mold 12 is made of an ultraviolet-transmitting material and the other portion is made of a non-ultraviolet-transmitting material. Examples of the ultraviolet-transmitting material include glass, quartz, polyester-based resin, polycarbonate-based resin, acrylic-based resin, polycarbonate-based resin, tetrafluoroethylene-(perfluoroalkyl vinyl ether) copolymer (PFA), polyvinylidene difluoride (PVDF), polyvinyl fluoride (PVF), tetrafluoroethylene-ethylene copolymer (ETFE), polychlorotrifluoroethylene (ECTFE), cycloolefin polymer (COP), and the like. Among these, from the viewpoint of handling and transparency, PFA is preferable. One type of the ultraviolet-transmitting material can be used, or two or more types can be used in combination.

Mold 12 can have a cavity, depending on the shape of the sealing material to be produced. In FIG. 3, the cavity can be formed by upper mold 12a and substrate 16. In the case where ultraviolet rays are applied from above the mold, only the upper mold needs to transmit ultraviolet rays. Preferably, upper mold 12a is made of PFA.

Mold 12 can comprise a filling-nozzle slot into which a filling nozzle is inserted for filling the ultraviolet-curable sealing material composition. Preferably, the filling-nozzle slot has a shape that can fit with the filling nozzle. Mold 12 may further have a runner portion. The filling-nozzle slot may be connected to the runner portion, and the runner portion may be connected to the cavity.

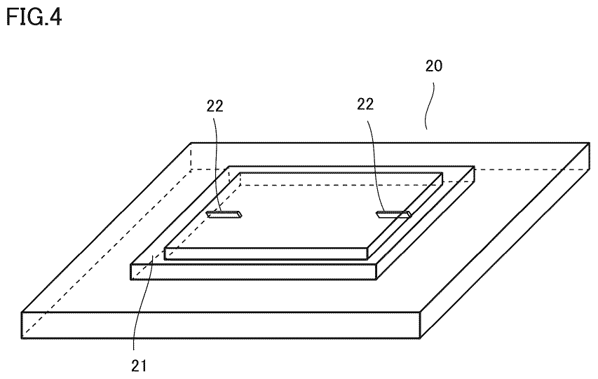

Mold 12 may have one or more filling-nozzle slots, one or more cavities, and one or more runner portions. When it has a plurality of filling-nozzle slots, it is possible to fill the ultraviolet-curable sealing material composition from multiple positions, and thereby the duration of the filling step can be shortened. The filling-nozzle slot may be positioned to be directly connected to the cavity, or it may be positioned to be connected to the cavity via the runner portion. The runner portion is a pathway through which the ultraviolet-curable sealing material composition flows to reach the cavity. FIG. 4 is a schematic view of the mold viewed from diagonally above. Referring to FIG. 4, a mold 20 has a cavity 21 and a runner portion 22. Runner portion 22 is connected to cavity 21. To runner portion 22, a filling-nozzle slot (not shown) may be connected.

In the filling step, with the use of filling apparatus 13, the ultraviolet-curable sealing material composition can be filled into mold 12. Preferably, filling apparatus 13 comprises a filling nozzle for filling the ultraviolet-curable sealing material composition into mold 12. Filling apparatus 13 can comprise one or more filling nozzles. The tip of the filling nozzle may have the shape of a frustum.

At the time of filling the ultraviolet-curable sealing material composition into mold 12, for easy flow of the ultraviolet-curable sealing material composition inside mold 12, a vacuum can be created in mold 12 before filling.

By providing a pressure sensor to, for example, runner portion 22 of mold 12 and acquire data, in advance, about the relationship between the flow of the ultraviolet-curable sealing material composition and the pressure, it is possible to control the completion of filling by using the pressure at runner portion 22. It is also possible to control the completion of filling by converting the pressure into the filling time.

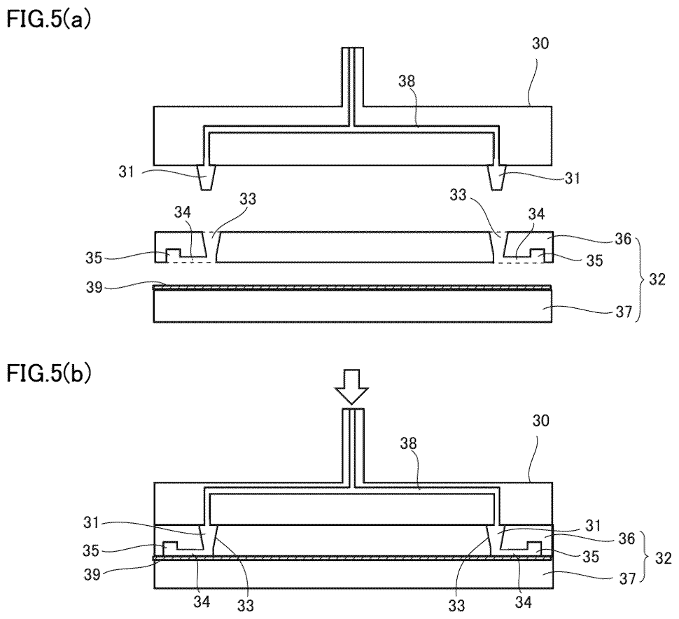

FIG. 5(a) and FIG. 5(b) illustrate cross sections of a filling apparatus and a mold. In FIG. 5(a), a filling apparatus 30 comprises a filling nozzle 31 and a runner portion 38; a mold 32 is composed of an upper mold 36, a substrate 39, and a lower mold 37; and upper mold 36 has a filling-nozzle slot 33, a runner portion 34, and a cavity 35. Filling nozzle 31 has the shape of a frustum. Referring to FIG. 5(b), filling the ultraviolet-curable sealing material composition into mold 32 can be carried out by combining upper mold 36, substrate 39, and lower mold 37 together, then inserting the filling nozzle 31 into filling-nozzle slot 33, then supplying the ultraviolet-curable sealing material composition through the runner portion 38 into the filling nozzle 31 in the direction of the arrow in the drawing, and then filling it through the runner portion 34 into cavity 35. Filling nozzle 31 can be inserted deep into the filling-nozzle slot 33.

UV irradiator 14 can comprise a light source such as a metal halide lamp, an LED, and/or the like, for example. The conditions of ultraviolet irradiation such as the time for applying ultraviolet rays, the illuminance of the ultraviolet rays, and the cumulative amount of light, for example, can be adjusted in accordance with the curing rate of the ultraviolet-curable sealing material composition.

In the mold releasing step, the sealing material is taken out from the mold. Referring to FIG. 3, sealing material 15 is taken out as it remains on substrate 16. The surface of the part of the mold that forms the cavity can undergo mold-releasing treatment before the ultraviolet-curable sealing material composition is filled, so that the sealing material can be taken out from the mold with ease. Examples of the mold-releasing treatment include application of a mold release agent, fluorine treatment of the mold surface, and the like.

The ultraviolet-curable sealing material composition is a composition that is curable when irradiated with ultraviolet rays. The ultraviolet-curable sealing material composition can contain an ultraviolet-curable resin component and a photopolymerization initiator.

Examples of the ultraviolet-curable resin component include rubber-based resin, polyolefin-based resin, acrylic-based resin, epoxy resin, silicone-based resin, urethane-based resin, vinyl alkyl ether-based resin, polyvinylpyrrolidone-based resin, polyacrylamide-based resin, cellulose-based resin, and the like. The ultraviolet-curable resin component may include a polyolefin-based resin, an acrylic resin, or an epoxy resin. A cured product of these resins can have a cross-linking point and can have rubber-like elasticity.

Examples of the rubber-based resin include isoprene rubber, butadiene rubber, styrene-butadiene rubber, chloroprene rubber, nitrile rubber, ethylene-propylene rubber, chlorosulfonated polyethylene rubber, acrylic rubber, fluorine rubber, epichlorohydrin rubber, urethane rubber, silicone rubber, and the like. Examples of the polyolefin-based resin include polyisobutylene and the like. Examples of a commercially available product of an ultraviolet-curable sealing material composition including a polyolefin-based resin include ThreeBond 3178 (manufactured by ThreeBond) and the like.

The content of the ultraviolet-curable resin component in the solid matter of the ultraviolet-curable sealing material composition may be 50 mass % or more, for example, and it is preferably 50 mass % or more, more preferably 60 mass % or more, further preferably 70 mass % or more, particularly preferably 80 mass % or more, specially preferably 90 mass % or more. The content of the ultraviolet-curable resin component in the solid matter of the ultraviolet-curable sealing material composition may be 99 mass % or less, or may be 98 mass % or less, for example.

Examples of the photopolymerization initiator include a photo-cationic polymerization initiator, a photo-radical polymerization initiator, and the like.

The content of the photopolymerization initiator relative to the amount of the ultraviolet-curable resin component (100 parts by mass) may be from 0.001 parts by mass to 10 parts by mass, for example, and it is preferably from 0.005 parts by mass to 10 parts by mass, more preferably from 0.01 parts by mass to 10 parts by mass.

The ultraviolet-curable sealing material composition can further include a crosslinking agent, other resin components, an additive, a filler, and/or the like.

The viscosity of the ultraviolet-curable sealing material composition may be 500 Pa·s or less, for example, and from the viewpoint of fillability, it is preferably 300 Pa·s or less, more preferably 200 Pa·s or less. The viscosity of the ultraviolet-curable sealing material composition is measured with a B type viscometer, for example. The viscosity at the time of filling may be lowered by heating.

### Sealing Material

The sealing material according to the present invention contains a cured product of an ultraviolet-curable sealing material composition. The ultraviolet-curable sealing material composition is as described above. The sealing material according to the present invention is produced by the above-described production method. The sealing material produced by the above-described production method is cured inside the mold, and, therefore, unlike a sealing material produced by applying an ultraviolet-curable sealing material composition directly to a substrate and curing the same, it can have a portion that has a tetragonal cross section in the thickness direction. The tetragonal shape may be square or rectangular. The ultraviolet-curable sealing material composition preferably contains a rubber-based resin, an acrylic resin, or an epoxy resin from the viewpoint of physical properties in a normal state.

The shape of the sealing material viewed in the thickness direction is not particularly limited, and it may be circular, tetragonal, ring-shaped, frame-shaped, and/or the like. The total dimension of the sealing material when viewed in the thickness direction of the sealing material may be from 50 mm to 1000 mm, or from 100 mm to 700 mm, or from 200 mm to 500 mm, for example. In the case where the sealing material is ring-shaped or frame-shaped, the width when viewed in the thickness direction may be from 0.1 mm to 4 mm, or from 0.5 mm to 2 mm. for example.

The thickness of the sealing material may be from 0.01 mm to 10 mm, or from 0.05 mm to 5 mm, or from 0.1 mm to 1 mm, for example.

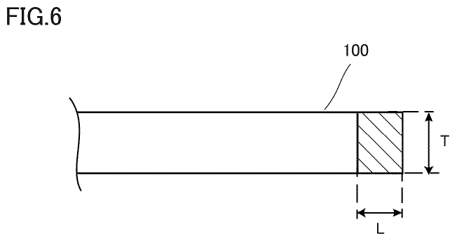

FIG. 6 illustrates a cross section of a portion of a frame-shaped sealing material where a cross section in the thickness direction is tetragonal. As illustrated in FIG. 6, a sealing material 100 may have a portion where the length T in the thickness direction (the thickness) is greater than the length L in a direction vertical to the thickness direction. The ratio of T to L (T/L) can be from 1.0 to 2.0, for example.

The sealing material according to the present invention can be produced by the method of producing a sealing material described above. By the method of producing a sealing material described above, it is possible to cure the ultraviolet-curable sealing material composition while it remains inside the mold, and, therefore, even though it contains a cured product of an ultraviolet-curable sealing material composition, the sealing material can have a portion that has a tetragonal cross section in the thickness direction.

The sealing material according to the present invention may have a runner, and it may have a parting line along the juncture of the components of the mold.

The sealing material according to the present invention can be used for any purpose of use, and it may be used for any purpose where a sealing material is used, such as, for example, vehicles, aircrafts, ships, internal combustion engines, production apparatuses, plants, medical products, construction, semiconductors, food, and batteries. Moreover, the sealing material according to the present invention can be combined with a mold, a resin part, and/or a sheet of various types and molded into a one-piece article, a composite article, and/or the like.

### EXAMPLES

In the following, the present invention will be described in further detail by way of Examples. “%” and “part(s)” in Examples refer to mass % and part(s) by mass, respectively, unless otherwise specified.

### Preparation of Ultraviolet-Curable Sealing Material Composition

Polyisobutylene and a photopolymerization initiator were mixed together and stirred to prepare an ultraviolet-curable sealing material composition.

### Example 1

In a mold preparation step, an SUS plate was placed between an upper mold and a lower mold (both made of PFA resin) to prepare a mold. The upper mold had a filling-nozzle slot, a minner portion, and a gate potion. The mold was transferred to a filling step by a conveyor belt, and into the filling-nozzle slot, the filling nozzle of the filling apparatus was inserted. From the filling nozzle, the ultraviolet-curable sealing material composition was filled into the cavity of the mold. Then, the filling nozzle was detached from the mold. Subsequently, the mold filled with the ultraviolet-curable sealing material composition was transferred to an irradiation step, where it was irradiated with ultraviolet rays by a UV irradiator equipped with a metal halide lamp and thereby the ultraviolet-curable sealing material composition was cured.

Subsequently, the resultant was transferred to a mold releasing step where the sealing material together with the SUS plate was detached from the mold. The sealing material had a frame-like shape, a thickness of 0.1 mm, a total size of 200 mm×500 mm when viewed in the thickness direction, and a width of 2 mm.

### REFERENCE SIGNS LIST

10 production apparatus, 11 transfer apparatus, 12 mold, 13 filling apparatus, 14 UV irradiator, 15 sealing material, 16 substrate, 20 mold, 21 cavity, 22, 34, 38 runner portion, 30 filling apparatus, 31 filling nozzle, 32 mold, 33 filling-nozzle slot, 35 cavity, 36 upper mold, 37 lower mold, 100 sealing material.

1. A method of producing a sealing material in a continuous manner, the method comprising:
a filling step to fill an ultraviolet-curable sealing material composition into a mold; and
an irradiation step to irradiate the ultraviolet-curable sealing material composition with ultraviolet rays, wherein
the mold transmits ultraviolet rays.

2. The method of producing a sealing material according to claim 1, wherein the mold is made of tetrafluoroethylene-(perfluoroalkyl vinyl ether) copolymer.

3. The method of producing a sealing material according to claim I, wherein the ultraviolet-curable sealing material composition contains an ultraviolet-curable resin component and a photopolymerization initiator.

4. The method of producing a sealing material according to claim 3, wherein the ultraviolet-curable resin component includes a polyolefin-based resin, an acrylic resin, or an epoxy resin.

5. The method of producing a sealing material according to claim I, wherein the method further includes at least one step selected from the group consisting of a mold preparation step, a mold releasing step, an inspection step, a cleaning step, a mold-release-agent application step, and a packaging step.

6. The method of producing a sealing material according to claim 1, wherein the method includes a step to place one type selected from the group consisting of a film, a plate, and a formed article.

7. The method of producing a sealing material according to claim 1, wherein the sealing material is produced continuously in at least one mode selected from the group consisting of a linear mode, a multi-line mode, and a rotational mode.

8. The method of producing a sealing material according to claim 1, wherein a plurality of steps are combined and implemented as one step.

9. The method of producing a sealing material according to claim 1, wherein a plurality of steps are implemented in parallel.

10. A sealing material comprising a cured product of an ultraviolet-curable sealing material composition.

11. The sealing material according to claim 10, wherein the ultraviolet-curable sealing material composition includes a polyolefin-based resin, an acrylic resin, or an epoxy resin.
